(19) United States
(12) Patent Application Publication
(10) Pub. No.: US 2006/0168274 A1
(43) Pub. Date: Jul. 27, 2006

(54) Method and system for high availability when utilizing a multi-stream tunneled marker-based protocol data unit aligned protocol

(76) Inventors: Eliezer Aloni, Zur Yigal (IL); Amit Oren, Palo Alto, CA (US); Caitlin Bestler, Laguna Hills, CA (US)

Correspondence Address: MCANDREWS HELD & MALLOY, LTD, 500 WEST MADISON STREET, SUITE 3400, CHICAGO, IL, 60661, US

(21) Appl. No.: 11/269,062

(22) Filed: Nov. 8, 2005

Related U.S. Application Data
(60) Provisional application No. 60/626,283, filed on Nov. 8, 2004.

(51) Int. Cl. G06F 15/16

(52) U.S. Cl. 709/230

(57) ABSTRACT

Aspects of a high reliability system for transporting information across a network via a TCP tunnel are presented. The TCP tunnel may include a plurality of TCP connections that may be logically associated with a single TCP tunnel. At least a portion of the plurality of TCP connections may be associated with each of a plurality of different network interfaces. In a fault tolerant system, at least a current portion of a plurality of messages communicated via an RDMA connection may be transported by a current TCP connection associated with a current network interface located at a current RNIC. In the event of a subsequent failure in the current TCP connection a subsequent portion of the plurality of messages may be communicated via a subsequent TCP connection associated with a different network interface. The different network interface may be located at the current RNIC or at a subsequent RNIC.

### CROSS-REFERENCE TO RELATED APPLICATIONS/INCORPORATION BY REFERENCE

This application makes reference to, claims priority to, and claims the benefit of U.S. Provisional Application Ser. No. 60/626,283 filed Nov. 8, 2004.

This application also makes reference to:

U.S. application Ser. No. ______ (Attorney Docket No. 17036US02) filed on even date herewith; and

U.S. application Ser. No. ______ (Attorney Docket No. 17097US02) filed on even date herewith.

Each of the above stated applications is hereby incorporated herein by reference in its entirety.

### FIELD OF THE INVENTION

Certain embodiments of the invention relate to data communications. More specifically, certain embodiments of the invention relate to a method and system for high availability when utilizing a multi-stream tunneled marker-based protocol data unit (PDU) aligned (MST-MPA) protocol.

### BACKGROUND OF THE INVENTION

In conventional computing, a single computer system is often utilized to perform operations on data. The operations may be performed by a single processor, or central processing unit (CPU) within the computer. The operations performed on the data may include numerical calculations, or database access, for example. The CPU may perform the operations under the control of a stored program containing executable code. The code may include a series of instructions that may be executed by the CPU that cause the computer to perform specified operations on the data. The capability of a computer in performing operations may variously be measured in units of millions of instructions per second (MIPS), or millions of operations per second (MOPS).

Historically, increases in computer performance have depended on improvements in integrated circuit technology, often referred to as “Moore's law”. Moore's law postulates that the speed of integrated circuit devices may increase at a predictable, and approximately constant, rate over time. However, technology limitations may begin to limit the ability to maintain predictable speed improvements in integrated circuit devices.

Another approach to increasing computer performance implements changes in computer architecture. For example, the introduction of parallel processing may be utilized. In a parallel processing approach, computer systems may utilize a plurality of CPUs within a computer system that may work together to perform operations on data. Parallel processing computers may offer computing performance that may increase as the number of parallel processing CPUs in increased. The size and expense of parallel processing computer systems result in special purpose computer systems. This may limit the range of applications in which the systems may be feasibly or economically utilized.

An alternative to large parallel processing computer systems is cluster computing. In cluster computing a plurality of smaller computer, connected via a network, may work together to perform operations on data. Cluster computing systems may be implemented, for example, utilizing relatively low cost, general purpose, personal computers or servers. In a cluster computing environment, computers in the cluster may exchange information across a network similar to the way that parallel processing CPUs exchange information across an internal bus. Cluster computing systems may also scale to include networked supercomputers. The collaborative arrangement of computers working cooperatively to perform operations on data may be referred to as high performance computing (HPC).

Cluster computing offers the promise of systems with greatly increased computing performance relative to single processor computers by enabling a plurality of processors distributed across a network to work cooperatively to solve computationally intensive computing problems. One aspect of cooperation between computers may include the sharing of information among computers. Remote direct memory access (RDMA) is a method that enables a processor in a local computer to gain direct access to memory in a remote computer across the network. RDMA may provide improved information transfer performance when compared to traditional communications protocols. RDMA has been deployed in local area network (LAN) environments such as InfiniBand, Myrinet, and Quadrics. RDMA, when utilized in wide area network (WAN) and Internet environments, is referred to as RDMA over TCP, RDMA over IP, or RDMA over TCP/IP.

One of the problems attendant with some distributed cluster computing systems is that the frequent communications between distributed processors may impose a processing burden on the processors. The increase in processor utilization associated with the increasing processing burden may reduce the efficiency of the computing cluster for solving computing problems. The performance of cluster computing systems may be further compromised by bandwidth bottlenecks that may occur when sending and/or receiving data from processors distributed across the network.

Once a TCP connection is established, it may be bound to a source network address and a destination network address. If either address becomes inaccessible, the corresponding TCP connection may fail. A network address may become inaccessible due to a failure at a single point in the path of the TCP connection between the source and destination.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for high availability when utilizing a multi-stream tunneled marker-based protocol data unit (PDU) aligned (MST-MPA) protocol, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a illustrates an exemplary distributed database processing environment, in connection with an embodiment of the invention.

FIG. 1b illustrates an exemplary system for multihoming, in connection with an embodiment of the invention.

FIG. 2 is an illustration of an exemplary conventional write operation from a local node to a remote node, in connection with an embodiment of the invention.

FIG. 3 is an illustration of an exemplary conventional write operation from a local node to a remote node, in connection with an embodiment of the invention.

FIG. 4 is an illustration of an exemplary conventional RDMA over TCP protocol stack, in connection with an embodiment of the invention.

FIG. 5 is an illustration of an exemplary RDMA over TCP protocol stack utilizing SCTP, in connection with an embodiment of the invention.

FIG. 6 is a block diagram of an exemplary system for an MST-MPA protocol, in accordance with an embodiment of the invention.

FIG. 7 is a block diagram of an exemplary system for high availability when utilizing an MST-MPA with a single RNIC, in accordance with an embodiment of the invention.

FIG. 8 is a block diagram of fault recovery in an exemplary system for high availability when utilizing an MST-MPA with a single RNIC, in accordance with an embodiment of the invention.

FIG. 9 is a block diagram illustrating data striping in an exemplary system for high availability when utilizing an MST-MPA with a single RNIC, in accordance with an embodiment of the invention.

FIG. 10 is a block diagram of an exemplary system for high availability when utilizing an MST-MPA with a duplex RNIC configuration, in accordance with an embodiment of the invention.

FIG. 11 is a block diagram of an exemplary system for high availability when utilizing an MST-MPA with a duplex RNIC configuration, in accordance with an embodiment of the invention.

FIG. 12 is a flowchart illustrating an exemplary process for high availability when utilizing a MST-MPA protocol, in accordance with an embodiment of the invention.

### DETAILED DESCRIPTION OF THE INVENTION

Certain embodiments of the invention may be found in a method and system for high availability when utilizing a multi-stream tunneled marker-based PDU aligned (MST-MPA) protocol. The invention may comprise a method and a system that may enable reliable communications between cooperating processors in a cluster computing environment while reducing the amount of processing burden in comparison to some conventional approaches to inter-processor communication among processors in the cluster. Various embodiments of the invention may provide high availability that enables fault tolerant reliable communications.

Various aspects of the invention may provide an exemplary system for transporting information and may comprise a processor that enables establishment of TCP connections or communication channels between a local remote direct memory access (RDMA) enabled network interface card (RNIC) and at least one remote RNIC via at least one network. The processor may enable establishment of at least one RDMA connection between one of a plurality of local RDMA endpoints and at least one remote RDMA endpoint utilizing one or more of the communication channels. The processor may further enable communication of messages via the established RDMA connections between one of the plurality of local RDMA endpoints and at least one remote RDMA endpoint independent of whether the messages are in-sequence or out-of-sequence.

In various embodiments of the invention, an RDMA connection may be transported, between a local RDMA endpoint and a remote RDMA endpoint, across a network via a TCP tunnel. The TCP tunnel may comprise a plurality of TCP connections that may be logically associated with a single TCP tunnel. The TCP tunnel may also be associated with a plurality of different network interfaces and/or network routes. At least a portion of the plurality of different network interfaces may be associated with at least one RNIC. At least a portion of the plurality of TCP connections may be associated with each of the plurality of different network interfaces. In a fault tolerant system, at least a current portion of a plurality of messages communicated via an RDMA connection may be transported by a current TCP connection associated with a current network interface located at a current RNIC. In the event of a subsequent failure in the current TCP connection a subsequent portion of the plurality of messages may be communicated via a subsequent TCP connection associated with a different network interface. The subsequent TCP connection may be associated with the same TCP tunnel as the current TCP connection. The different network interface may be located at the current RNIC or at a subsequent RNIC.

The ability to send a current portion of a plurality of messages via a current interface, and a subsequent portion of the plurality of messages via a subsequent interface may be referred to as multi-homing. Various embodiments of the invention may enable multi-homing to be utilized with RDMA over TCP. TCP may provide mechanisms by which each of a plurality of messages may be delivered to a destination node once, and in the order in which a source node transmitted the messages, when utilizing a single interface. Various embodiments of the invention may provide mechanisms by which each of the plurality of messages may be delivered to the destination node once, and in the order in which the source node sent the messages, when utilizing a plurality of interfaces.

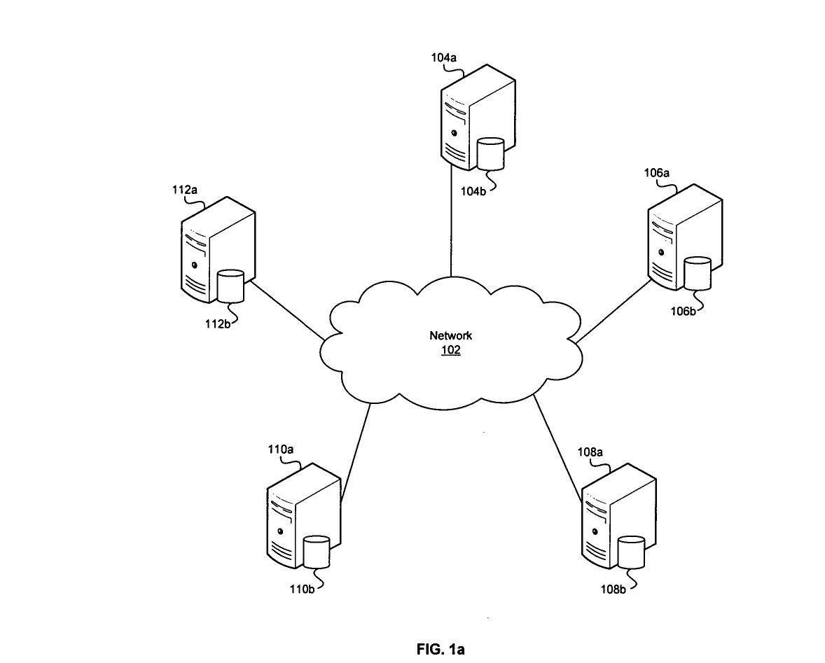

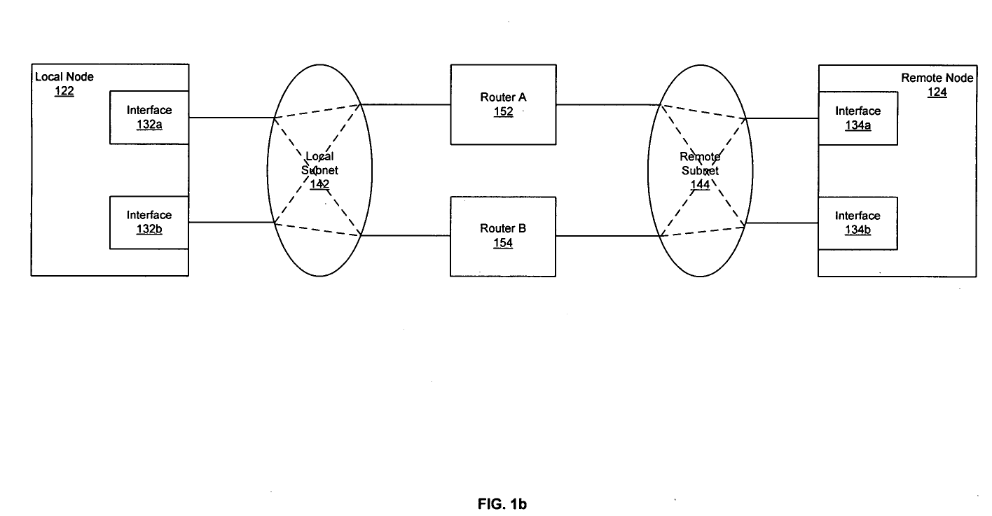

FIG. 1a illustrates an exemplary distributed database processing environment, in connection with an embodiment of the invention. Referring to FIG. 1a, there is shown a network 102, a plurality of computer systems 104a, 106a, 108a, 110a, and 112a, and a corresponding plurality of database applications 104b, 106b, 108b, 110b, and 112b. The computer systems 104a, 106a, 108a, 110a, and 112a may be coupled to the network 102. One or more of the computer systems 104a, 106a, 108a, 110a, and 112a may execute a corresponding database application 104b, 106b, 108b, 110b, and 112b, respectively, for example. In general, a plurality of software processes, for example a database application, may be executing concurrently at a computer system.

In a distributed processing environment, such as in distributed database processing, for example, a database application, for example 104b, may communicate with one or more peer database applications, for example 106b, 108b, 110b, or 112b, via a network, for example, 102. The operation of the database application 104b may be considered to be coupled to the operation of one or more of the peer databases 106b, 108b, 110b, or 112b. A plurality of applications, for example database applications, which execute cooperatively, may form a cluster environment. A cluster environment may also be referred to as a cluster. The applications that execute cooperatively in the cluster environment may be referred to as cluster applications.

In some conventional cluster environments, a cluster application may communicate with a peer cluster application via a network by establishing a network connection between the cluster application and the peer application, exchanging information via the network connection, and subsequently terminating the connection at the end of the information exchange. An exemplary communications protocol that may be utilized to establish a network connection is the Transmission Control Protocol (TCP). RFC 793 discloses communication via TCP and is hereby incorporated herein by reference. An exemplary protocol that may be utilized to route information transported in a network connection across a network is the Internet Protocol (IP). RFC 791 discloses communication via IP and is hereby incorporated herein by reference. An exemplary medium for transporting and routing information across a network is Ethernet, which is defined by Institute of Electrical and Electronics Engineers (IEEE) resolution 802.3 is hereby incorporated herein by reference.

For example, database application 104b may establish a TCP connection to database application 110b. The database application 104b may initiate establishment of the TCP connection by sending a connection establishment request to the peer database application 110b. The connection establishment request may be routed from the computer system 104a, across the network 102, to the computer system 110a, via IP. The peer database application 110b may respond to the received connection establishment request by sending a connection establishment confirmation to the database application 104b. The connection establishment confirmation may be routed from the computer system 110a, across the network 102, to the computer system 104a, via IP.

After establishing the TCP connection, the database application 104b may issue a query to the database application 110b via the established TCP connection. In response to the query, the database application 110b may access data stored at computer system 110a. The database application 110b may subsequently send the accessed information to the database application 104b via the established TCP connection. The database application 104b may send an acknowledgement of receipt of the accessed data to the database application 110b via the established TCP connection. The database application 104b may terminate the established TCP connection by sending a connection terminate indication to the database application

In a cluster environment comprising N computer systems wherein P cluster applications, or software processes, are concurrently executing at each of the computer systems, the number of connections, NC, that may be established across a network at a given time instant may be:

$$NC = \frac{{P}^{2} N ( N - 1 )}{2} \qquad equation [ 1 ]$$

An exemplary cluster environment may comprise 8 computing systems, for example 104a, wherein 8 cluster applications, for example 104b, are executing at each of the 8 computer systems. In this exemplary regard, 1,712 connections may be established across a network, for example 102, at a given time instant.

Many of the connections established in some conventional cluster environments may be transient in nature. This may be true, for example, in transaction oriented cluster environments in which a cluster application may establish a connection when it needs to communicate with a peer cluster application across a network. At the completion of the communication, or transaction, the connection may be terminated. At a subsequent time instant, when the cluster application and peer cluster application needs to communicate, the process of connection establishment, transaction, and connection termination may be repeated. The processing overhead required for maintaining large numbers of connections and/or frequent connection establishment and connection terminations may significantly decrease the processing efficiency of the cluster.

FIG. 1b illustrates an exemplary system for multihoming, in connection with an embodiment of the invention. Referring to FIG. 1b, there is shown a local node 122, a remote node 124, a local subnet 142, a remote subnet 144, router 152 and router 154. The local node 122 may comprise interfaces 132a and 132b. The remote node may comprise routers 134a and 134b.

The local subnet 142 may communicatively couple the local interface 132a and router 152. The local subnet 142 may also communicatively couple the local interface 132a and router 154. The local subnet 142 may communicatively couple the local interface 132b and router 152. The local subnet 142 may also communicatively couple the local interface 132b and router 154.

The local subnet 144 may communicatively couple the local interface 134a and router 152. The local subnet 144 may also communicatively couple the local interface 134a and router 154. The local subnet 144 may communicatively couple the local interface 134b and router 152. The local subnet 144 may also communicatively couple the local interface 134b and router 154.

Each of the interfaces and routers may be associated with at least one network address. For example, the interface 132a may be associated with network addresses 192.168.1.17 and 192.168.1.19. The interface 132b may be associated with network addresses 192.168.3.17 and 192.168.3.19. The interface 134a may be associated with network addresses 192.168.2.18 and 192.168.2.20. The interface 134b may be associated with network addresses 192.168.4.18 and 192.168.4.20. The router 152 may be associated with network address 192.168.1.1 at local subnet 142. The router 152 may be associated with network address 192.168.2.1 at local subnet 144. The router 154 may be associated with network address 192.168.3.1 at local subnet 142. The router 154 may be associated with network address 192.168.4.1 at local subnet 144.

The local subnets 142 and 144, and routers 152 and 154 may be utilized to establish at least one route between the interface 132a and interface 134a. The local subnets 142 and 144, and routers 152 and 154 may be utilized to establish at least one route between the interface 132a and interface 134b. The local subnets 142 and 144, and routers 152 and 154 may be utilized to establish at least one route between the interface 132b and interface 134a. The local subnets 142 and 144, and routers 152 and 154 may be utilized to establish at least one route between the interface 132b and interface 134b. The routes may be utilized to send an IP frame from a source address 192.168.1.17 located in the local node 122 to a destination address 192.168.2.18 in the remote node 124.

Multihoming may comprise utilizing a plurality of different routes to send information between the local node 122 and the remote node 124. Information may be sent between the local node 122 and remote node 124 via IP frames, for example. The IP frame may comprise a source address indicating the sender, and a destination address indicating the recipient. The source and destination addresses may be utilized when routing the IP frame between the local node 122 and remote node 124. A first exemplary route may comprise sending an IP frame from network address 192.168.1.17, via the local subnet 142, to the router 152 at network address 192.168.1.1, and from the router 152 at network address 192.168.2.1, via the remote subnet 144, to the destination address 192.168.2.18. A second exemplary route may comprise sending an IP frame from network address 192.168.3.17, via the local subnet 142, to the router 154 at network address 192.168.3.1, and from the router 154 at network address 192.168.4.1, via the remote subnet 144, to the destination address 192.168.4.18. A third exemplary route may comprise sending an IP frame from network address 192.168.1.19, via the local subnet 142, to the router 152 at network address 192.168.1.1, and from the router 152 at network address 192.168.2.1, via the remote subnet 144, to the destination address 192.168.2.20. A fourth exemplary route may comprise sending an IP frame from network address 192.168.3.19, via the local subnet 142, to the router 154 at network address 192.168.3.1, and from the router 154 at network address 192.168.4.1, via the remote subnet 144, to the destination address 192.168.4.20.

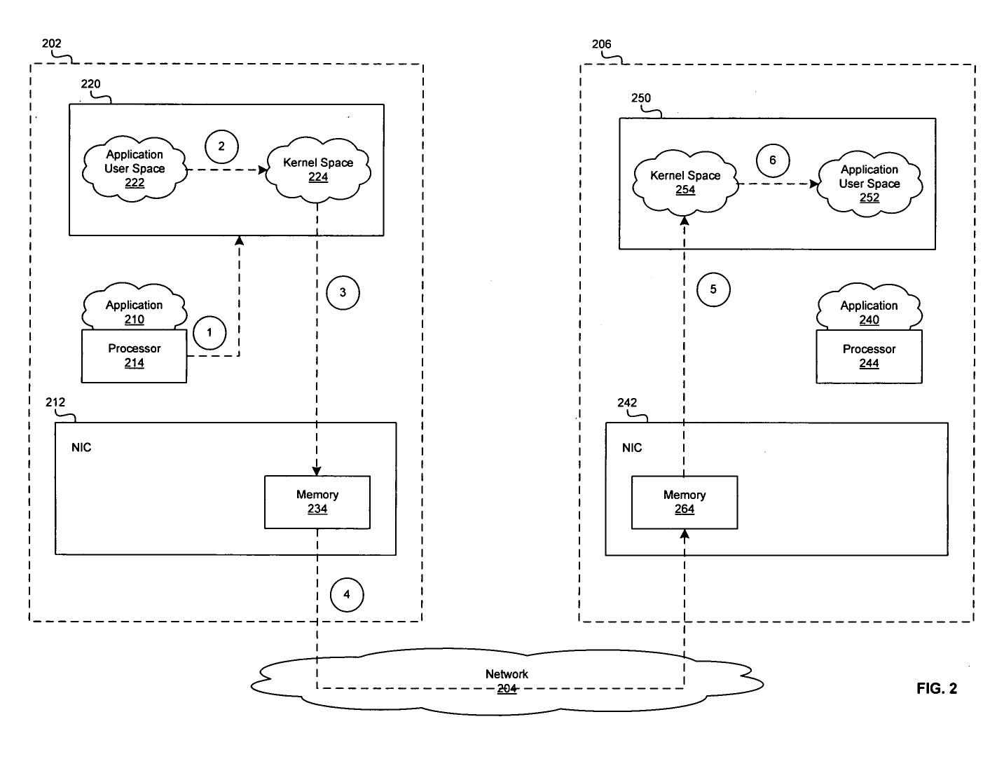

FIG. 2 is an illustration of an exemplary conventional write operation from a local node to a remote node, in connection with an embodiment of the invention. Referring to FIG. 2 there is shown a local node 202, a remote node 206, and a network 204. The local node 202 may comprise a system memory 220, a network interface card (NIC) 212, and a processor 214. Within in context of a cluster environment, a local computer system may be referred to as a local node while a remote computer system may be referred to as a remote node. The system memory 220 may comprise memory, which may store an application user space 222 and a kernel space 224. The processor 214 may execute an application 210. The NIC 212 may comprise a memory 234.

The remote node 206 may comprise a system memory 250, an NIC 242, and a processor 244. The system memory 250 may comprise an application user space 252 and/or a kernel space 254. The processor 244 may execute an application 240. The NIC 242 may comprise a memory 264.

The system memory 220 may comprise suitable logic, circuitry, and/or code that may be utilized to store, or write, and/or retrieve, or read, information, data, and/or executable code. The system memory 220 may comprise a plurality of memory technologies such as random access memory (RAM). The system memory 220 may be utilized to store and/or retrieve data that may be processed by the processor 214. The memory 220 may comprise computer program or code, which may be executed by the processor 214.

The application user space 222 may comprise a portion of information, and/or data that may be utilized by the application 210. The kernel space 224 may comprise a portion of information, data, and/or code associated with an operating system or other execution environment that provides services that may be utilized by the application 210. The processor 214 may comprise suitable logic, circuitry, and/or code that may be utilized to transmit, receive and/or process data. The processor 214 may execute an application 210, for example a database application. The application 210 may comprise at least one code section that may be executed by the processor 214.

The network interface chip/card (NIC) 212 may comprise suitable circuitry, logic and/or code that may transmit and/or receive data from a network, for example, an Ethernet network. The NIC 212 may be coupled to the network 204. The NIC 212 may process data received and/or transmitted via the network 204.

The system memory 250 may comprise suitable logic, circuitry, and/or code that may be utilized to store, or write, and/or retrieve, or read, information, data, and/or executable code. The system memory 250 may comprise different types of exemplary random access memory (RAM) such as DRAM and/or SRAM. The system memory 250 may be utilized to store and/or retrieve data that may be processed by the processor 244. The memory 250 may store a computer program or code that may be executed by the processor 244.

The application user space 252 may comprise a portion of information, and/or data that may be utilized by the application 240. The kernel space 254 may comprise a portion of information, data, and/or code associated with an operating system or other execution environment that provides services that may be utilized by the application 240. The processor 244 may comprise suitable logic, circuitry, and/or code that may be utilized to transmit, receive and/or process data. The processor 244 may execute an application 240 or code, such as, for example a database application. The application 240 may comprise at least one code section that may be executed by the processor 244. The NIC 242 may comprise suitable circuitry, logic and/or code that may enable transmission and/or reception of data from a network, for example, an Ethernet network. The NIC 242 may be coupled to the network 204. The NIC 242 may process data received and/or transmitted via the network 204.

In operation, the local node 202 may transfer data to the remote node 206 via the network 204. The data may comprise information that may be transferred from the application user space 222 in the local node 202 to the application user space 252 in the remote node 206. The application 210 may cause the processor 214 to issue instructions to the system memory 220 as illustrated in segment 1 of FIG. 2. The instruction illustrated in segment 1 may cause information stored in the application user space 222 to be transferred to the kernel space 224 as illustrated in segment 2. The information may be subsequently transferred from the kernel space 224 to the NIC memory 234 as illustrated in segment 3. The NIC 212 may cause the information to be transferred from the memory 234 in the local node 202, via the network 204, to the memory 264 within the NIC 242 in the remote node 206 as illustrated in segment 4. The information may be transferred from the system memory 264 to the kernel space 254 within the system memory 250 in the remote node 206 as illustrated in segment 5. The information in the kernel space 254 may be transferred to the application user space 252 as illustrated in segment 6.

The remote direct memory access (RDMA) protocol may provide a more efficient method by which a database application, for example, executing at a local computer system may exchange information with a remote computer system across the network 102. For example, an RDMA based transfer of information may be accomplished without requiring the intervening step of transferring the information from application user space to kernel space as illustrated in FIG. 2.

The RDMA protocol may include two basic operations, an RDMA write operation, and an RDMA read operation. A third operation is a send/receive operation. The RDMA write operation may be utilized to transfer data from a local computer system to the remote computer system. The RDMA read operation may be utilized to retrieve data from a remote computer system that may subsequently be stored at the local computer system. For example, the database application 104b executing at a local computer system 104a may attempt to retrieve information stored at a remote computer system 110a. The database application 104b may issue the RDMA read instruction that may be sent across the network 102, and received by the remote computer system 110a. The requested information may subsequently be retrieved from the remote computer system 110a, transported across the network 102, and stored at the local computer system 104a.

The database application 104b executing at the local computer system 104a may attempt to transfer information to the remote computer system 110a by issuing an RDMA write instruction that may be sent from the local computer system 104a, across the network 102, and received by the remote computer system 110a. The database application 104b may subsequently cause the local computer system 104a to send information across the network 102 that is stored at the remote computer system 110a.

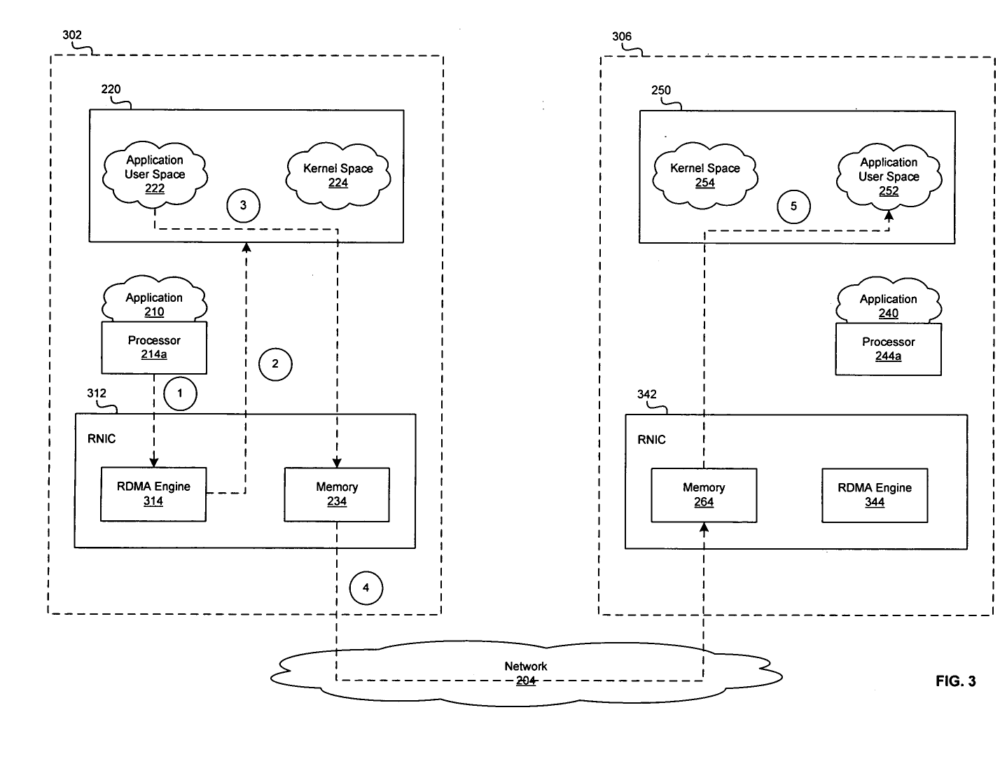

FIG. 3 is an illustration of an exemplary conventional write operation from a local node to a remote node, in connection with an embodiment of the invention. Referring to FIG. 3 there is shown a local node 302, a remote node 306, and a network 204. The local node 302 may comprise a system memory 220, an RDMA-enabled network interface card (RNIC) 312, and a processor 214. The system memory 220 may comprise an application user space 222 and/or a kernel space 224. The processor 214 may execute an application 210. The RNIC 312 may comprise an RDMA engine 314, and a memory 234.

The remote node 306 may comprise a system memory 250, an RNIC 342, and a processor 244. The RNIC 342 may comprise an RDMA engine 344 and a memory 264. The RNIC 312 may comprise suitable circuitry, logic and/or code that may enable transmission and reception of data from a network, for example, an Ethernet network. The RNIC 312 may be coupled to the network 204. The RNIC 312 may process data received and/or transmitted via the network 204.

The RDMA engine 314 may comprise suitable logic, circuitry, and/or code that may be utilized to send instructions to system memory 220 and/or memory 234 that may result in the transfer of information from the local node 302 to the remote node 306 via the network 204. The RDMA engine 314 may be programmed with a local memory address, a local node address, a remote memory address, a remote node address, and a length. The RDMA engine 314 may then cause a block of information of a size, length, starting at location, local memory address, within the system memory 220 of the local node 302, local node address, to be transferred via the network 204 to a location starting at location, remote memory address, within the system memory 250 of the remote node 306, remote node address.

The RNIC 342 may comprise suitable circuitry, logic and/or code that may transmit and receive data from a network, for example, an Ethernet network. The RNIC 342 may be coupled to the network 204. The RNIC 342 may process data received and/or transmitted via the network 204.

The RDMA engine 344 may comprise suitable logic, circuitry, and/or code that may be utilized to send instructions to system memory 250 and/or memory 264 that may result in the transfer of information from the remote node 306 to the local node 302 via the network 204 as described for the RDMA engine 314.

In operation, the local node 302 may transfer data to the remote node 306 via the network 204. The data may comprise information that may be transferred from the application user space 222 in the local node 202 to the application user space 252 in the remote node 206. The application 210 may cause the processor 214 to issue instructions to the RDMA engine 314 as illustrated in segment 1 of FIG. 2. The instructions may comprise a local memory address, local node address, remote memory address, remote node address, and length. The instruction illustrated in segment 1 may cause the RDMA engine 314 to issue instructions to the system memory 220 as illustrated in segment 2. The instructions as illustrated in segment 2 may cause information stored in the application user space 222 to be transferred to the RNIC memory 234 as illustrated in segment 3. The RNIC 312 may cause the information to be transferred from the memory 234 in the local node 302, via the network 204, to the memory 264 within the RNIC 342 in the remote node 306 as illustrated in segment 4. The information may be transferred from the system memory 264 to the application user space 252 as illustrated in segment 5.

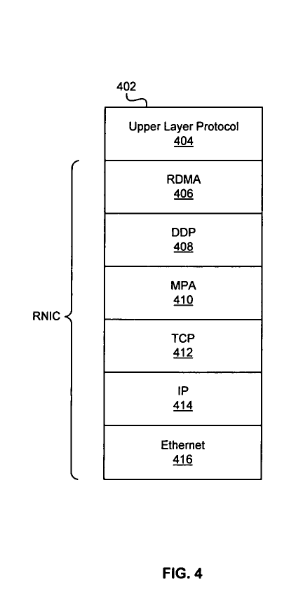

FIG. 4 is an illustration of an exemplary conventional RDMA over TCP protocol stack, in connection with an embodiment of the invention. Referring to FIG. 4, there is shown a conventional RDMA over TCP protocol stack 402. The RDMA over TCP protocol stack 402 may comprise an upper layer protocol 404, an RDMA protocol 406, a direct data placement protocol (DDP) 408, a marker-based PDU aligned protocol (MPA) 410, a TCP 412, an IP 414, and an Ethernet protocol 416. An RNIC may comprise functionality associated with the RDMA protocol 406, DDP 408, MPA protocol 410, TCP 412, IP 414, and Ethernet protocol 416.

The RDMA protocol specifies various methods that may enable a local computer system to exchange information with a remote computer system via a network 204. The methods may comprise an RDMA read operation and/or an RDMA write operation. The RDMA protocol may also comprise the establishment of an RDMA connection between the local computer system and the remote computer system prior to the exchange of information. An RDMA connection may be established by, for example, a local computer system that sends an RDMA connection request message to the remote computer system and, in response, the remote computer system that sends an RDMA response message to the local computer system. The local computer system and remote computer system may subsequently utilize the established RDMA connection to exchange information via the network 204. The exchange of information may comprise a local computer system that sends one or more sequence numbered frames to the remote computer system. The exchange of information may also comprise a remote computer system that sends one or more sequence numbered frames to the local computer system. The sequence numbers may indicate a relative ordering among frames. For example, the sequence number in a current frame may indicate, to the receiver of the frame, a relationship between the current frame and a preceding frame and/or subsequent frame.

The DDP 408 may enable copy of information from an application user space in a local computer system to an application user space in a remote computer system without performing an intermediate copy of the information to kernel space. This may be referred to as a “zero copy” model. The DDP 408 may embed information in each transmitted sequence numbered frame that enables information contained in the frame to be copied to the application user space in the remote computer system. This copy may be done regardless of whether a current sequence numbered frame is received in-sequence, or out-of-sequence, relative to a preceding sequence numbered frame, or subsequent sequence numbered frame, that is sent via the established RDMA connection.

The MPA protocol 410 may comprise methods that enable frames transmitted in an RDMA connection to be transported, via the network 204, via a TCP connection. The MPA protocol 410 may enable a single TCP connection to carry frames associated with a corresponding single RDMA connection. In the transmitting direction, the MPA protocol 410 may receive a sequence numbered frame associated with an RDMA connection. The MPA protocol 410 may derive information from the received RDMA frame to identify the corresponding RDMA connection. The MPA protocol 410 may determine the corresponding TCP connection associated with the RDMA connection. The MPA protocol 410 may utilize the sequence numbered frame from the RDMA connection, or RDMA sequence numbered frame, to form a TCP packet. The formation of a TCP packet from the RDMA sequence numbered frame may be referred to as encapsulation, for example. The TCP packet may be transmitted, via the network 204, utilizing the corresponding TCP connection.

In the receiving direction, the MPA protocol 410 may receive a TCP packet associated with a TCP connection from the network 204. The MPA protocol 410 may derive information from the received TCP packet to determine the corresponding RDMA connection associated with the TCP connection. The MPA protocol 410 may extract an RDMA sequence numbered frame from the TCP packet. The extraction of an RDMA sequence numbered frame from the TCP packet may be referred to as decapsulation, for example. At least a portion of the information contained within the received RDMA sequence numbered frame, referred to as a payload, may be copied to the application user space.

The TCP 412, and IP 414 may comprise methods that enable information to be exchanged via a network according to applicable standards as defined by the Internet Engineering Task Force (IETF). The Ethernet 416 may comprise methods that enable information to be exchanged via a network according to applicable standards as defined by the IEEE.

In operation, the local node 302 may transfer data to the remote node 306 via the network 204. An upper layer protocol 404 may comprise an application 210 that issues an RDMA write request to write information from the application user space 222 to the application user space 254. The RDMA write request may cause the RDMA protocol 406 to establish an RDMA connection between the local node 302, and the remote node 306. The RDMA protocol 406 may send a connection request message to the remote computer system 306. In response, the MPA protocol 410 may request that the TCP 412 establish a TCP connection between the local node 302 and the remote node 306. Upon establishment of the TCP connection the MPA protocol 410 may encapsulate at least a portion of the RDMA connection request message in a TCP packet that may be sent to the remote node 306 via the established TCP connection. The MPA protocol 410 may subsequently receive a TCP packet containing the corresponding RDMA response message. The MPA protocol 410 may decapsulate the TCP packet and send at least a portion of the RDMA response message to the RDMA protocol 406. Accordingly, a TCP connection may be established between the local node 302 and the remote node 306. The TCP connection may be utilized by a corresponding RDMA connection to exchange information via the network 204.

An upper layer protocol 404 may be utilized to transfer information from the local node 302 in an RDMA sequence numbered frame to the remote node 306 via established the RDMA connection. At the completion of the information transfer from the local node 302 to the remote node 306, the RDMA connection may be terminated. Correspondingly, the TCP connection utilized in connection with the RDMA connection may also be terminated.

In a conventional RDMA over TCP implementation the number of RDMA connections may be equal to the number of TCP connections. Consequently, in a cluster environment, the total number of TCP and RDMA connection may be equal to twice the number of connections as indicated in equation[1].

The total number of connections may be reduced if a single TCP connection is utilized to transport information corresponding to a plurality of RDMA connections between the local node 302 and the remote node 306. In this case, the TCP connection may be utilized as a tunnel. One approach to TCP tunneling may utilize the stream control transport protocol (SCTP).

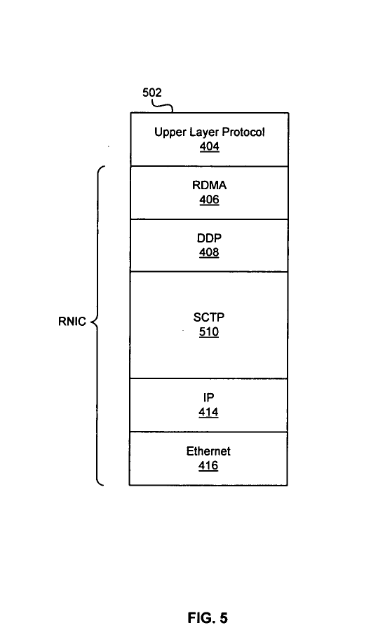

FIG. 5 is an illustration of an exemplary RDMA over TCP protocol stack utilizing SCTP, in connection with an embodiment of the invention. Referring to FIG. 5, there is shown a conventional RDMA over TCP protocol stack 502. The RDMA over TCP protocol stack 502 may comprise an upper layer protocol 404, an RDMA protocol 406, a direct data placement protocol 408, an SCTP 510, an IP 414, and an Ethernet protocol 416. An RNIC may comprise functionality associated with the RDMA protocol 406, DDP 408, SCTP 510, IP 414, and Ethernet protocol 416.

Aspects of the SCTP 510 may comprise functionality equivalent to the MPA protocol 410 and TCP 412. In addition, the SCTP 510 may allow a TCP connection to correspond to a plurality of RDMA connections. The SCTP 510 may comprise methods that enable frames transmitted in an RDMA connection to be transported, via the network, through an SCTP association. An SCTP association may comprise functionality comparable to a TCP connection. For the purposes of this application, an SCTP association may also be referred to as an SCTP connection. An SCTP connection, however, may incorporate additional functionality beyond a TCP connection that may enable the SCTP connection to be utilized as a tunnel. The SCTP 510 may enable a single SCTP connection to carry frames associated with a corresponding plurality of RDMA connections.

SCTP 510 may be utilized in the exemplary protocol stack 502 to reduce the total number of connections in a cluster environment in comparison to the exemplary protocol stack 402. One disadvantage in the utilization of SCTP 510 is that an RNIC may be required to store executable code that may comprise overlapping functionality. For example, a TCP 412 stack may typically be stored in an RNIC. To take advantage of the tunneling capability of SCTP 510, the RNIC may be required to store executable code for SCTP 510, including code that comprises functionality that substantially overlaps that of TCP 412. In addition, some intermediate nodes within the network 204, may be unable to process packets in an SCTP connection. For example, firewalls and/or port network address translation (PNAT) nodes may be unable to process packets transported in an SCTP connection.

Various embodiments of the invention may provide a method and a system for tunneling a plurality of RDMA connections within a TCP connection. In one aspect, this may enable greater reuse of existing protocol stacks stored in the RNIC while achieving the benefits of tunneling. Various embodiments of the invention may be utilized with existing network infrastructures that comprise firewall nodes, PNAT nodes, and/or devices that implement various security methods within the network 204.

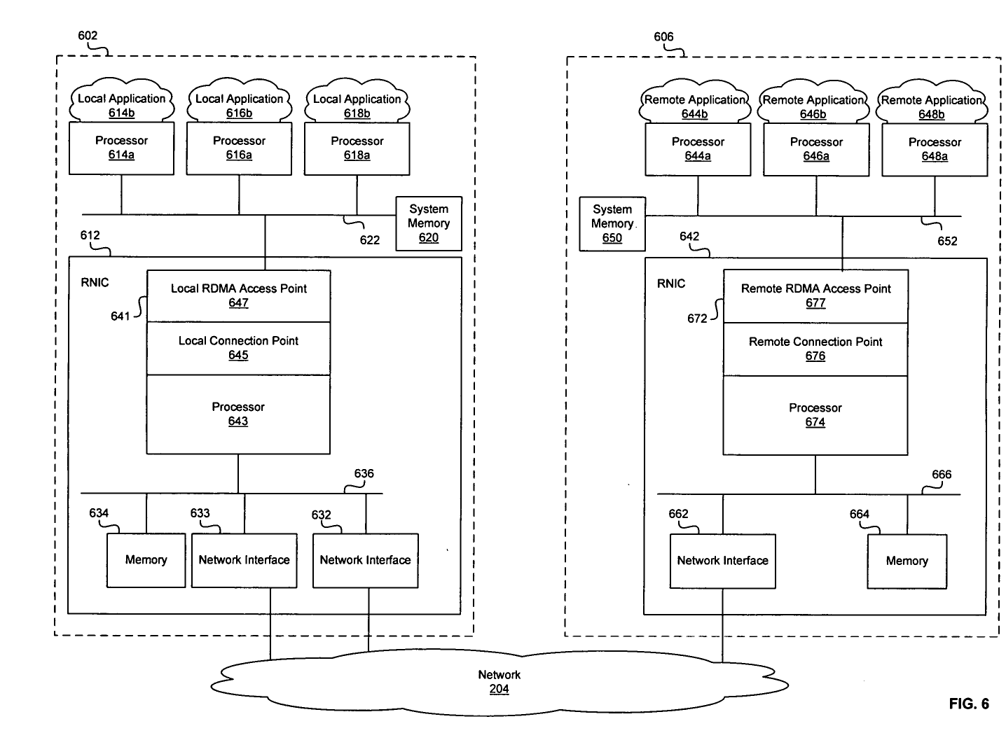

FIG. 6 is a block diagram of an exemplary system for an MST-MPA protocol, in accordance with an embodiment of the invention. Referring to FIG. 6, there is shown a network 204, and a local computer system 602, and a remote computer system 606. The local computer system 602 may comprise an RDMA-enabled network interface card (RNIC) 612, a plurality of processors 614a, 616a and 618a, a plurality of local applications 614b, 616b, and 618b, a system memory 620, and a bus 622. The RNIC 612 may comprise a TCP offload engine (TOE) 641, a memory 634, a plurality of network interfaces 632 and 633, and a bus 636. The TOE 641 may comprise a processor 643, a local connection point 645, and a local RDMA access point 647. The remote computer system 606 may comprise a RNIC 642, a plurality of processors 644a, 646a, and 648a, a plurality of remote applications 644b, 646b, and 648b, a system memory 650, and a bus 652. The RNIC 642 may comprise a TOE 672, a memory 664, a network interface 662, and a bus 666. The TOE 672 may comprise a processor 674, a remote connection point 676, and a remote RDMA access point.

The processor 614a may comprise suitable logic, circuitry, and/or code that may be utilized to transmit, receive and/or process data. The processor 614a may execute application code, for example a database application. The processor 614a may be coupled to a bus 622. The processor 614a may perform protocol processing when transmitting and/or receiving data via the bus 622.

In the transmitting direction, the protocol processing performed by the processor 614a may comprise receiving data and/or instructions from an application 614b, for example. The data may comprise one or more upper layer protocol (ULP) protocol data units (PDU). The instructions may comprise instructions that cause the processor 614a to perform tasks related to the RDMA protocol. The instructions may result from function calls from an RDMA application programming interface (API). An instruction may cause the processor 614a to perform steps to initiate one or more RDMA connections.

In the receiving direction the protocol processing performed by the processor 614a may comprise receiving ULP PDUs via the bus 622 that were received via the NIC 612. The processor 614a may perform protocol processing on at least a portion of the ULP PDU received from the NIC 612, via the bus 622. At least a portion of the ULP PDU may be subsequently utilized by an application 614b, for example.

The local application 614b may comprise a computer program that comprises at least one code section that may be executable by the processor 614a for causing the processor 614a to perform steps comprising protocol processing, in accordance with an embodiment of the invention. The processor 616a may be substantially as described for the processor 614a. The local application 616b may be substantially as described for the local application 614b. The processor 618a may be substantially as described for the processor 614a. The local application 618b may be substantially as described for the local application 614b.

The system memory 620 may comprise suitable logic, circuitry, and/or code that may be utilized to store, or write, and/or retrieve, or read, information, data, and/or executable code. The system memory 620 may comprise a plurality of as random access memory (RAM) technologies such as, for example, DRAM. The system memory 620 may be utilized to store and/or retrieve data and/or PDUs that may be processed by one or more of the processors 614a, 616a, or 618a. The memory 620 may comprise code that may be executed by the one or more of the processors 614a, 616a, or 618a.

The RNIC 612 may comprise suitable circuitry, logic and/or code that may transmit and/or receive data from a network, for example, an Ethernet network. The RNIC 612 may be coupled to the network 604. The RNIC 612 may enable the local computer system 602 to utilize RDMA to exchange information with a peer computer system in a cluster environment. The RNIC 612 may process data received and/or transmitted via the network 204. The RNIC 612 may be coupled to the bus 622. The RNIC 612 may process data received and/or transmitted via the bus 622. In the transmitting direction, the RNIC 612 may receive data via the bus 622. The NIC 612 may process the data received via the bus 622 and transmit the processed data via the network 204. In the receiving direction, the RNIC 612 may receive data via the network 204. The RNIC 612 may process the data received via the network 204 and transmit the processed data via the bus 622.

The TOE 641 may comprise suitable logic, circuitry, and/or code to receive data via the bus 222 from one or more processors 614a, 614b, or 614c, and to perform protocol processing and to construct one or more packets and/or one or more frames. In the transmitting direction the TOE 641 may receive data via the bus 622. The TOE 641 may perform protocol processing that encapsulates at least a portion of the received data in a protocol data unit (PDU) that may be constructed in accordance with a protocol specification, for example, RDMA. The RDMA PDU may be referred to as an RDMA frame, or frame. The TOE 641 may also perform protocol processing that encapsulates at least a portion of the RDMA frame in a PDU that may be constructed in accordance with a protocol specification, for example, TCP.

The TCP PDU may be referred to as a TCP packet, or packet. The portion of the RDMA frame may in turn be contained in one or more MST-MPA protocol messages. In addition to containing at least a portion of an RDMA frame, the MST-MPA protocol message may contain a frame length, source endpoint identifier, destination endpoint identifier, source sequence number, and/or error check fields. At least a portion of the MST-MPA protocol message may then be contained in a TCP packet. The TCP protocol processing may comprise constructing one or more PDU header fields comprising source and/or destination network addresses, source and/or destination port identifiers, and/or computation of error check fields. The packet may be transmitted via the bus 236 for subsequent transmission via the network 204. In various embodiments of the invention, the TOE 641 may associate a plurality of RDMA connections with a TCP connection. The TCP connection may be utilized as a tunnel that transports encapsulated MST-MPA protocol messages, or portions thereof, in TCP packets across a network 204 via the TCP connection.

In the receiving direction the TOE 641 may receive PDUs via the bus 636 that were previously received via the network 204. The TOE 641 may perform TCP protocol processing that decapsulates at least a portion the PDU received from the network 204, via the bus 236 in accordance with a protocol specification, to extract one or more MST-MPA protocol messages. The TCP protocol processing may comprise verifying one or more PDU header fields comprising source and/or destination network addresses, source and/or destination port identifiers, and/or computations to detect and/or correct bit errors in the received PDU. The MST-MPA protocol processing may comprise verifying source and/or destination endpoint identifiers, source sequence numbers, and/or computations to detecte and/or correct bit errors in the received MST-MPA protocol message. The RDMA frame may be derived from one or more lower layer protocol PDUs, for example, one or more MST-MPA protocol messages. The TOE 641 may perform RDMA protocol processing that decapsulates at least a portion of the RDMA frame to extract data. The RDMA protocol processing may comprise verifying one or more frame header fields comprising frame length, source endpoint identifier, destination endpoint identifier, source sequence number and/or error check fields. The data may be subsequently processed by the TOE 641 any transmitted via the bus 622.

The TOE 641 may cause at least a portion of a PDU that was received via the bus 636 that was previously received via the network 204 to be stored in the memory 634. The TOE 641 may cause at least a portion of a PDU, which is to be subsequently transmitted via the network 204, to be stored in the memory 634. The TOE 641 may cause an intermediate result, comprising a PDU or data, which is processed at least in part by the TOE 641, to be stored in the memory 634.

The memory 634 may comprise suitable logic, circuitry, and/or code that may be utilized to store, or write, and/or retrieve, or read, information, data, and/or executable code. The memory 634 may comprise a random access memory (RAM) such as DRAM and/or SRAM. The memory 634 may be utilized to store and/or retrieve data and/or PDUs that may be processed by the TOE 641. The memory 634 may store code that may be executed by the TOE 641.

The network interface 632 may comprise suitable logic, circuitry, and/or code that may be utilized to transmit and/or receive PDUs via a network 204. The network interface may be coupled to the network 204. The network interface 632 may be coupled to the bus 636. The network interface 632 may receive bits via the bus 636. The network interface 632 may subsequently transmit the bits via the network 204 that may be contained in a representation of a PDU by converting the bits into electrical and/or optical signals, with timing parameters, and with signal amplitude, energy and/or power levels as specified by an appropriate specification for a network medium, for example, Ethernet. The network interface 632 may also transmit framing information that identifies the start and/or end of a transmitted PDU.

The network interface 632 may receive bits that may be contained in a PDU received via the network 204 by detecting framing bits indicating the start and/or end of the PDU. Between the indication of the start of the PDU and the end of the PDU, the network interface 632 may receive subsequent bits based on detected electrical and/or optical signals, with timing parameters, and with signal amplitude, energy and/or power levels as specified by an appropriate specification for a network medium, for example, Ethernet. The network interface 632 may subsequently transmit the bits via the bus 636. The network interface 633 may be substantially as described for network interface 632.

The processor 643 may comprise suitable logic, circuitry, and/or code that may be utilized to perform at least a portion of the protocol processing tasks within the TOE 641.

The local connection point 645 may comprise a computer program and/or code may be executable by the processor 643, which may perform RDMA and/or TCP protocol processing. Exemplary protocol processing may comprise establishment of TCP tunnels, in accordance with an embodiment of the invention.

The local RDMA access point 647 may comprise a computer program that comprises at least one code section that may be executable by the processor 643 for causing the processor 643 to perform steps comprising protocol processing, for example protocol processing related to the establishment of RDMA connection and/or the association of a plurality of RDMA connections with a corresponding one or more TCP tunnels, in accordance with an embodiment of the invention.

The processor 644a may be substantially as described for the processor 614a. The processor 644a may be coupled to the bus 652. The local application 644b may be substantially as described for the local application 614b. The processor 646a may be substantially as described for the processor 614a. The processor 646a may be coupled to the bus 652. The local application 646b may be substantially as described for the local application 614b. The processor 648a may be substantially as described for the processor 614a. The processor 648a may be coupled to the bus 652.

The local application 648b may be substantially as described for the local application 614b. The system memory 650 may be substantially as described for the system memory 620. The system memory 650 may be coupled to the bus 652. The RNIC 642 may be substantially as described for the RNIC 612. The RNIC 642 may be coupled to the bus 652. The TOE 672 may be substantially as described for the TOE 641. The TOE 672 may be coupled to the bus 652. The TOE 672 may be coupled to the bus 666. The network interface 662 may be substantially as described for the network interface 632. The network interface 662 may be coupled to the bus 666. The memory 664 may be substantially as described for the memory 634. The memory 664 may be coupled to the bus 666. The processor 674 may be substantially as described for the processor 643. The remote connection point 676 may be substantially as described for the local connection point 645. The remote RDMA access point 677 may be substantially as described for the local RDMA access point 647.

In operation, one or more local applications 614b, 616b, and/or 618b may attempt to establish a plurality of RDMA connections with one or more remote applications 644b, 646b, and/or 648b. In various embodiments of the invention, a corresponding plurality of TCP connections may be established between the local computer system 602, and the remote computer system 606. The TCP connections may be referred to as communication channels. The plurality of TCP connections may be associated with a TCP tunnel. The TCP tunnel may be associated with a plurality of network interfaces, for example network interfaces 633 and 634 located in the RNIC 612. Any of the plurality of TCP connections associated with the TCP tunnel may be utilized by at least a portion of the plurality of RDMA connections. An individual RDMA connection may utilize at least a portion of the plurality of TCP connections. An individual TCP connection among the plurality of TCP connections may be associated with a single network interface among the plurality of network interfaces. For example, in a TCP tunnel comprising two individual TCP connections, a first TCP connection may be associated with a first network interface 633, while a second TCP connection may be associated with a second network interface 634. A TCP connection may be associated with a network interface if information transported across a network 204 via the TCP connection utilizes the network interface. An RDMA connection may utilize the first TCP to transport a current portion of a plurality messages, and the second TCP connection to transport a subsequent portion of the plurality of messages.

In a fault tolerant embodiment of the invention that utilizes a single RNIC 612, the RDMA connection may utilize the first TCP connection to transport at least a portion of the plurality of messages. If a failure occurs in the first TCP connection such that the local computer system 602 is unable to continue sending messages to the remote computer system 606, subsequent messages may utilize the second TCP connection.

In the above example, the first TCP connection may be referred to as the active TCP connection with respect to the RDMA connection, while the second TCP connection may be referred to as the standby TCP connection. The active or standby status of a TCP connection may be with respect to a single RDMA connection. For example, a second RDMA connection that utilizes the tunnel may utilize the second TCP connection as the active TCP connection, while utilizing the first TCP connection as the standby TCP connection.

The routing of the first TCP connection within the network 204 may differ from the routing of the second TCP connection. In one aspect, a first network interface 633 may be coupled to a first access router or switch within the network 204, while a second network interface 634 may be coupled to a second access router or switch within the network 204. In this regard, failure of a single component within the network, or a single point of failure, may not result in a failure of both the first and second TCP connections. Similarly, the utilization of a plurality of network interfaces at the RNIC 612 may enable the TCP tunnel to transport messages associated with the RDMA connection in the event of a failure of a single network interface 633 or 634. In general, each of the TCP connections within a TCP tunnel should follow a different route, within the network, between the local computer system and the remote computer system. The routes may be evaluated by, for example, estimating a distance between a local network address and a remote network address within the network.

In a fault tolerant embodiment of the invention that utilizes a plurality of RNICs, the TCP tunnel may comprise a plurality of TCP connections associated with interfaces located at each RNIC. For example, in a TCP tunnel comprising four individual TCP connections, a first TCP connection may be associated with a first network interface located at the first RNIC, while a second TCP connection may be associated with a second network interface located at the first RNIC. Furthermore, a third TCP connection may be associated with a first network interface located at the second RNIC, while a fourth TCP connection may be associated with a second network interface located at the second RNIC. An RDMA connection may utilize the first TCP connection to transport at least a portion of the plurality of messages. If a failure occurs in the first TCP connection such that the local computer system 602 is unable to continue sending messages to the remote computer system 606, subsequent messages may utilize the third TCP connection.

An RDMA connection may comprise state information about the connection. For example, MST-MPA protocol messages sent via the RDMA connection may be sequence numbered. In embodiments of the invention that utilize a plurality or RNICs, the RNICs may exchange information about the state of individual RDMA connections that utilize the respective RNICs. For example, in the above example, when the RDMA connection utilized the first TCP connection, the first RNIC may maintain state information related to the RDMA connection. The first RNIC may be referred to as the active RNIC with respect to the RDMA connection. The second RNIC, which was utilized when the first TCP connection failed, may be referred to as the standby RNIC with respect to the RDMA connection. The active RNIC may update the standby RNIC with state information related to the RDMA connection. This process of active RNIC to standby RNIC updating of information may be referred to as checkpointing.

In the above example, the RDMA connection utilized the first TCP connection, which was associated with the first interface located at the first RNIC, as the active TCP connection. Consequently, the first RNIC was the active RNIC. The active or standby status of an RNIC may be with respect to a single RDMA connection. For example, a second RDMA connection that utilizes the tunnel may utilize the second RNIC as the active RNIC, while utilizing the first RNIC as the standby RNIC. The second RDMA connection may utilize the third TCP connection, which was associated with the first interface located at the second RNIC, as the active TCP connection. In the event of a failure of the third TCP connection, the second RDMA connection may utilize the first TCP connection, for example.

In a data striping embodiment of the invention, the network interfaces 633 and 634 may be utilized to provide an aggregate increase in the data transfer rate across the network 204. For example, an RDMA connection may utilize the first TCP connection to transport a current portion of a plurality of messages while concurrently utilizing the second TCP connection to transport a subsequent portion of the plurality of messages. For example, an n^{th} message, sent via the RDMA connection, may utilize the first network interface 633, while an (n+1)^{th} message, also sent via the RDMA connection, may concurrently utilize the second network interface 634.

Once failure of a TCP connection within the TCP tunnel is detected, a new TCP connection may be established within the tunnel as a replacement for the failed TCP connection. Furthermore, the RNIC associated with the failed TCP connection may send probe messages to the network 204 to derive an indication of when the TCP connection failure may have ended. Probe messages may comprise one or more echo messages as specified by the Internet Control Message Protocol (ICMP), for example.

U.S. application Ser. No. ______ (Attorney Docket No. 17036US02) filed on an even date herewith, provides a detailed description of procedures for establishment of a communication channel, utilizing a TCP connection that may be utilized as a tunnel, and is hereby incorporated by reference in its entirety.

U.S. application Ser. No. ______ (Attorney Docket No. 17097US02) filed on an even date herewith, provides a detailed description of procedures for establishment of an RDMA connection that utilizes a TCP tunnel, and is hereby incorporated by reference in its entirety.

In various embodiments of the invention, a local TOE 641 may establish a high availability TCP tunnel to a remote TOE 672. The high availability tunnel may comprise a plurality of TCP connections. With respect to an individual RDCP connection that may utilize the TCP tunnel, one of the plurality of TCP connections may be an active TCP connection, while other TCP connections associated with the TCP tunnel may be standby connections. The local TOE 641 may send a connection request message to the remote TOE 672. The connection request message may comprise a plurality of elements. Exemplary elements may comprise a tunnel cookie, a maximum number of tunnel connections, and a list of one or more endpoint addresses. Optionally, a maximum endpoint identifier may be specified. The maximum endpoint identifier may identify one or more local endpoints 614b that may utilize the RDMA tunnel. The maximum endpoint identifier may correspond to a maximum local port value associated with an application associated with the corresponding local endpoint 614b. The local port value may identify a specific local endpoint 614b.

The tunnel cookie may represent an identifier of the TCP tunnel. This value may be useful when subsequently modifying the TCP tunnel. For example, when issuing a subsequent connection request message to add TCP connections, or remove existing TCP connections, the TCP tunnel may be utilized to authenticate the request. The maximum number of tunnel connections may represent an indication of the maximum number of TCP connections that may be contained within the established TCP tunnel. The number of TCP connections may be associated with a single RNIC or a plurality of RNICs.

The list of one or more endpoint identifiers may represent a plurality of local addresses. The local addresses may represent local network addresses that may be associated with a network interface located at an RNIC. The RNIC may be located at the local computer system 602. In various embodiments of the invention, each of the one or more endpoint identifiers may be associated with a different network interface and/or different access router or switch corresponding to a different route through the network 204. For example, in a connection request message comprising two endpoint identifiers, a first endpoint identifier may be associated with the network interface 633, while a second endpoint identifier may be associated with the network interface 634. The network address may enable the network 204 to route TCP connections, and the messages carried within RDMA connections that utilize the TCP connections, to be properly routed between an interface located at a local computer system 602 and a remote computer system 606 via the network 204.

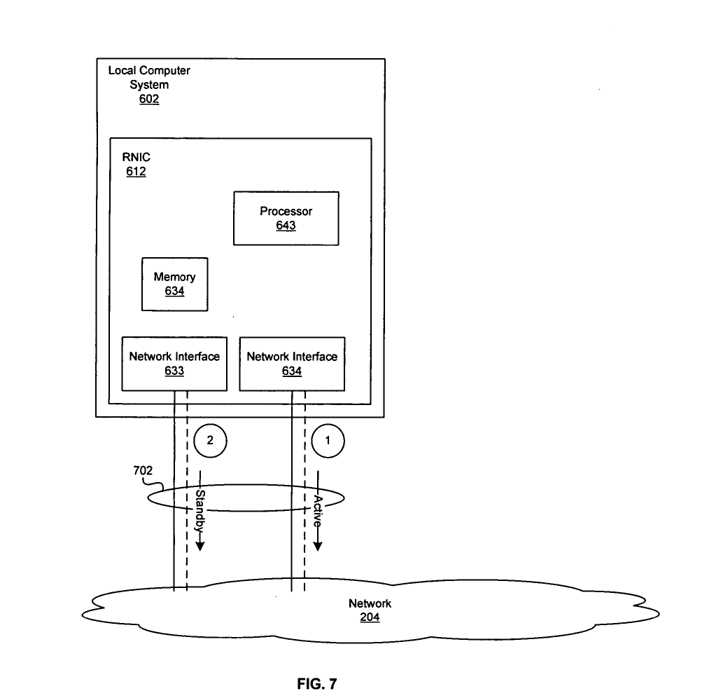

FIG. 7 is a block diagram of an exemplary system for high availability when utilizing an MST-MPA with a single RNIC, in accordance with an embodiment of the invention. Referring to FIG. 7, there is shown a network 204, a local computer system 602, and a TCP tunnel 702. The local computer system 602 may comprise an RNIC 612, a processor 643, a memory 634, and network interfaces 633 and 634.

The TCP tunnel 702 may comprise a plurality of TCP connections indicated by the reference numbers 1 and 2. The TCP tunnel 702 may comprise a plurality of TCP connections between the local computer system 602 and a remote computer system 606 via the network 204 as illustrated in FIG. 6. With reference to an RDMA connection that may utilize the TCP tunnel 702, the TCP connection 1 may represent an active TCP connection, while the TCP connection 2 may represent a standby TCP connection. The active TCP connection may be associated with the network interface 634, while the standby interface may be associated with the network interface 633. RDMA frames transported via an RDMA connection may utilize the TCP connection 1. The RDMA connection may be transported across the network 204 via the network interface 634. Various embodiments of the invention may not be limited to utilizing an established TCP connection 2. For example, upon failure of the TCP connection 1, a new TCP connection may be established within the tunnel. The new TCP connection may be established by sending a connection request message that comprises a tunnel cookie that identifies the TCP tunnel 702, for example.

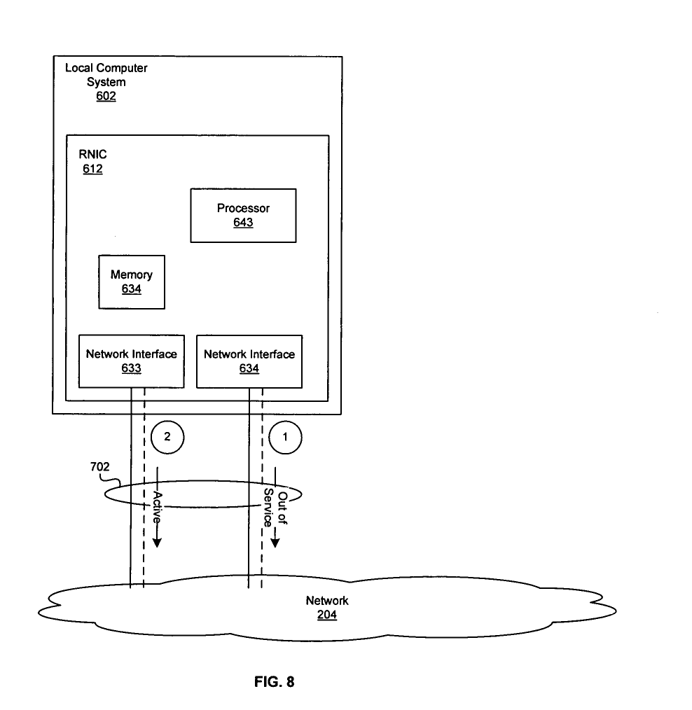

FIG. 8 is a block diagram of fault recovery in an exemplary system for high availability when utilizing an MST-MPA with a single RNIC, in accordance with an embodiment of the invention. Referring to FIG. 7, there is shown a network 204, a local computer system 602, and a TCP tunnel 702. The local computer system 602 may comprise an RNIC 612, a processor 643, a memory 634, and network interfaces 633 and 634.

FIG. 8 represents an annotation of FIG. 7 to illustrate a fault recovery response to a failure of an active TCP connection. The TCP connection 1 may fail for various reasons, for example, a cable may inadvertently be removed from the network interface 634, a hardware, software, or firmware failure may occur causing a failure at the network interface 634, or a failure may occur within the network 204. Similarly, a failure of the TCP connection 1 may be determined if failures are detected in other TCP connections that utilize the same network interface. The failure of the TCP connection 1 may be detected at the RNIC 612 by TCP procedures as specified in applicable TCP specifications. Upon detection of the failure of the TCP connection at the network interface 634, the processor 643 within the RNIC 612 may cause the active TCP connection 1 to enter an out-of-service state with respect to the RDMA connection. The standby TCP connection 2 may subsequently enter an active state with respect to the RDMA connection. Subsequent RDMA frames associated with the RDMA connection may be transported across the network 204 via the network interface 633.

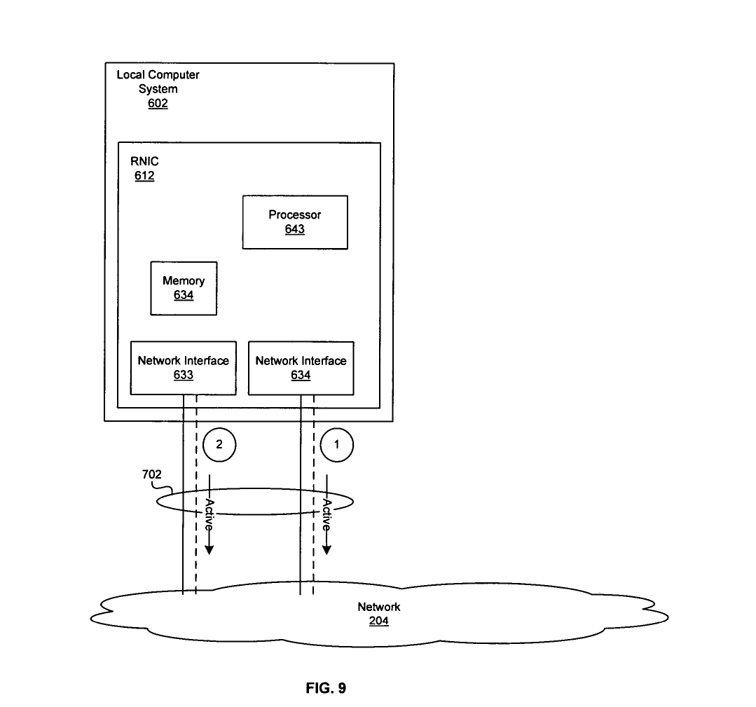

FIG. 9 is a block diagram illustrating data striping in an exemplary system for high availability when utilizing an MST-MPA with a single RNIC, in accordance with an embodiment of the invention. Referring to FIG. 9, there is shown a network 204, a local computer system 602, and a TCP tunnel 702. The local computer system 602 may comprise an RNIC 612, a processor 643, a memory 634, and network interfaces 633 and 634.

FIG. 9 represents an annotation of FIG. 7 to illustrate data striping. Data striping may utilize a plurality of network interfaces to enable information to be transported in an RDMA connection at a data rate that exceeds the data rate of a single network interface. In a data striping configuration, with reference to an RDMA connection that may utilize the TCP tunnel 702, the TCP connection 1 may represent an active TCP connection, while the TCP connection 2 may also represent an active TCP connection. In a data striping configuration a portion of RDMA frames from an RDMA connection may be transported via the TCP connection 1, while a subsequent portion of the RDMA frames from the RDMA connection may be concurrently transported via the TCP connection 2.

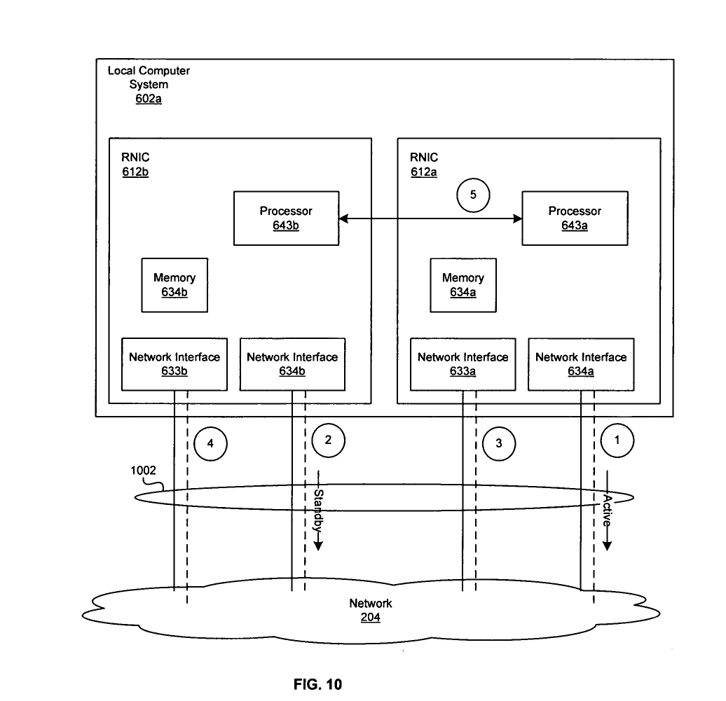

FIG. 10 is a block diagram of an exemplary system for high availability when utilizing an MST-MPA with a duplex RNIC configuration, in accordance with an embodiment of the invention. Referring to FIG. 10, there is shown a network 204, a local computer system 602, and a TCP tunnel 1002. The local computer system 602 may comprise an RNIC 612a, and an RNIC 612b. The RNIC 612a may comprise a processor 643a, a memory 634a, a network interfaces 633a and 634a. The RNIC 612b may comprise a processor 643b, a memory 634b, and network interfaces 633b and 634b. The RNIC 612b may be referred to as a mate RNIC to the RNIC 612a. The RNIC 612a may be referred as a mate RNIC to the RNIC 612b.

The TCP tunnel 1002 may comprise a plurality of TCP connections indicated by the reference numbers 1, 2, 3, and 4. The TCP tunnel 1002 may comprise a plurality of TCP connections between the local computer system 602 and a remote computer system 606 via the network 204 as illustrated in FIG. 6. With reference to an RDMA connection that may utilize the TCP tunnel 1002, the TCP connection 1 may represent an active TCP connection, while the TCP connection 2 may represent a standby TCP connection. The active TCP connection may be associated with the network interface 634a, while the standby interface may be associated with the network interface 634b. The TCP connection 3 may be associated with the network interface 633a. The TCP connection 4 may be associated with the network interface 633b. The network interfaces 633a and 634a may be located at the RNIC 612a, while the network interface 633b and 634b may be located at the RNIC 612b.

With respect to the RDMA connection, the RNIC 612a may represent an active RNIC 612a, while the RNIC 612b may represent a standby RNIC 612b. RDMA frames transported via an RDMA connection may utilize the TCP connection 1. The RDMA connection may be transported across the network 204 via the network interface 634b. The TCP connections 3 and 4 may be utilized by other RDMA connections. TCP connections 1 and 2 may also be utilized by other RDMA connections.

The processor 643a located in the RNIC 612a may checkpoint to the processor 643b located in the mate RNIC 612b. The checkpointing between the processors, indicated by the reference number 5, may comprise updating on the state of RDMA active connections carried via the respective RNICs. For example, the RNIC 612a may maintain state information related to RDMA connections that utilize active TCP connections associated with network interfaces 633a and 634a, while the RNIC 612b may maintain state information related to RDMA connections that utilize active TCP connections associated with network interfaces 633b and 634b. The processor 643a may checkpoint the processor 643b with state information related to active TCP connections associated with network interfaces 633a and 634a. The processor 643b may checkpoint the processor 643a with state information related to active TCP connections associated with network interfaces 633b and 634b.

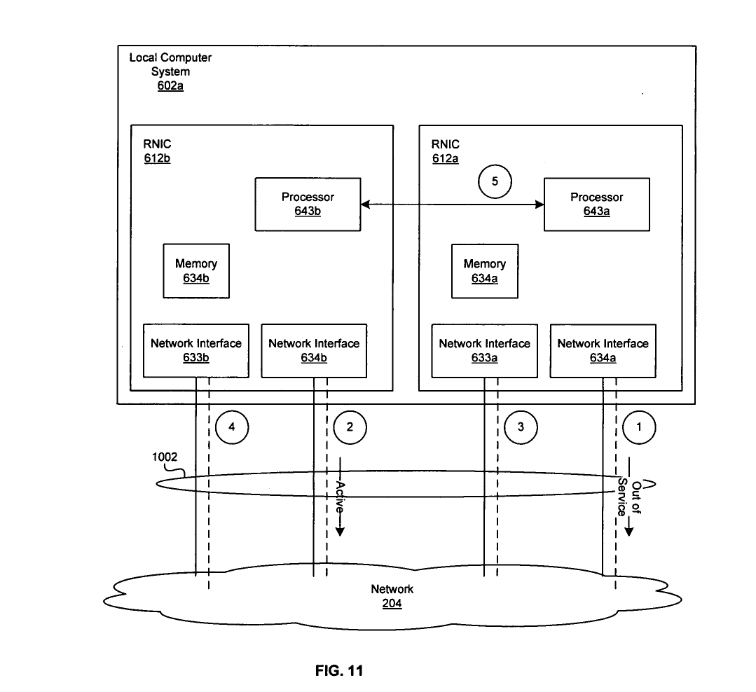

FIG. 11 is a block diagram of an exemplary system for high availability when utilizing an MST-MPA with a duplex RNIC configuration, in accordance with an embodiment of the invention. Referring to FIG. 10, there is shown a network 204, a local computer system 602, and a TCP tunnel 1002. The local computer system 602 may comprise an RNIC 612a, and an RNIC 612b. The RNIC 612a may comprise a processor 643a, a memory 634a, a network interfaces 633a and 634a. The RNIC 612b may comprise a processor 643b, a memory 634b, and network interfaces 633b and 634b. The RNIC 612b may be referred to as a mate RNIC to the RNIC 612a. The RNIC 612a may be referred as a mate RNIC to the RNIC 612b.

FIG. 11 represents an annotation of FIG. 10 to illustrate a fault recovery response to a failure of an active TCP connection. The failure of the TCP connection 1 may be detected at the RNIC 612a by TCP procedures as specified in applicable TCP specifications. Upon detection of the failure of the TCP connection at the network interface 634a, the processor 643a within the RNIC 612a may cause the active TCP connection 1 to enter an out-of-service state with respect to the RDMA connection. The processor 643a may checkpoint the processor 643b in the mate RNIC 612b to indicate the failure of the TCP connection 1 via the checkpointing link 5. The standby TCP connection 2 may subsequently enter an active state with respect to the RDMA connection. Subsequent RDMA frames associated with the RDMA connection may be transported across the network 204 via the network interface 634b. Various embodiments of the invention may not be limited to utilizing an established TCP connection 2. For example, upon failure of the TCP connection 1, a new TCP connection may be established within the tunnel. The new TCP connection may be established by sending a connection request message that comprises a tunnel cookie that identifies the TCP tunnel 1002, for example.

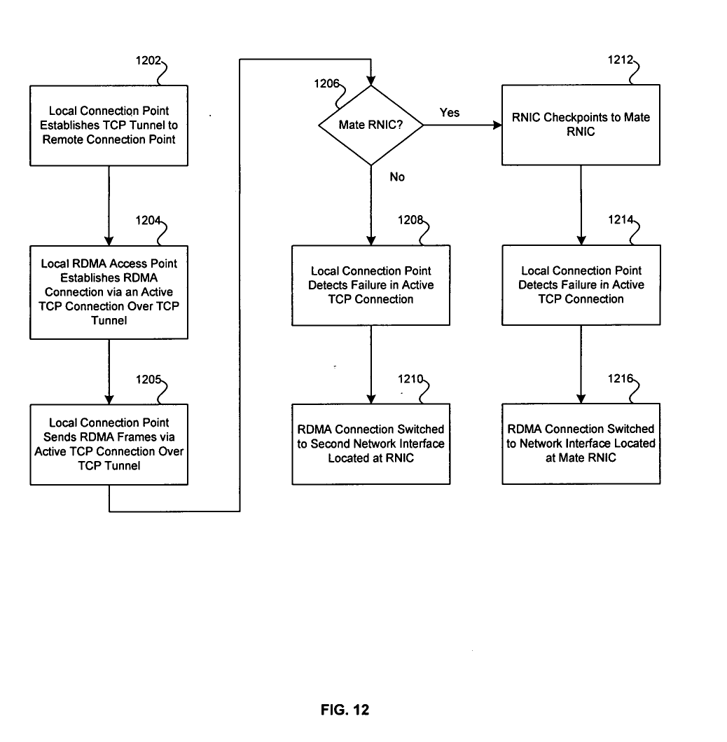

FIG. 12 is a flowchart illustrating an exemplary process for high availability when utilizing a MST-MPA protocol, in accordance with an embodiment of the invention. Referring to FIG. 12, in step 1202, a local connection point 645 may establish a TCP tunnel 1002 to a remote connection point 676 via a network 204. In step 1204, the local RDMA access point 647 may establish an RDMA connection via an active TCP connection over the TCP tunnel 1002. In step 1205, the local connection point 645 may send RDMA frames via the active TCP connection over the TCP tunnel 1002. Step 1206, may determine whether the local computer system 602 comprises a single RNIC 612a, or a plurality of RNICs, for example, a duplex configuration comprising a mate RNIC 612b. If there is no mate RNIC, in step 1208, the local connection point 645 may detect a failure in the active TCP connection. The local connection point 645 may receive notification of the failure of the active TCP connection from the network interface 633 and/or 634. In step 1210, the local connection point 645 may switch the RDMA connection from a current network interface 634 such that subsequent RDMA frames may be transported via a TCP connection associated with a subsequent network interface 633.

If there is a mate RNIC, in step 1212, the RNIC 612a may checkpoint the mate RNIC 612b. In step 1214, the local connection point 645 may detect a failure in the active TCP connection. The local connection point 645 may receive notification of the failure of the active TCP connection from the network interface 633a and/or 634a. In step 1216, the local connection point 645 may switch the RDMA connection from a current network interface 634a such that subsequent RDMA frames may be transported via a TCP connection associated with a subsequent network interface 634b located at the mate RNIC 612b.

Aspects of a system for transporting information via a communications system may include a processor 643 that may enable establishing a plurality of TCP communication channels between a local RDMA enabled NIC (RNIC) 612 and at least one of a plurality of remote RNICs 642. Each of the plurality of TCP communication channels may be communicatively coupled to a plurality of different network interfaces at the local RNIC 612. The processor 643 may enable establishing of RDMA connections between one of a plurality of local RDMA endpoints and at least one remote RDMA endpoint utilizing the established plurality of TCP communication channels. The processor 643 may enable communicating of a portion of a plurality of messages from one of a plurality of local RDMA endpoints communicatively coupled to a first of the plurality of different network interfaces at the local RNIC. The portion of the plurality of messages may be communicated to at least one remote RDMA endpoint communicatively coupled to one of the plurality of remote RNICs via a first of the established plurality of TCP communication channels. The processor 643 may also enable communicating a remaining portion of the plurality of messages from one of the plurality of local RDMA endpoints communicatively coupled to a second of the plurality of different network interfaces at the local RNIC. The remaining portion of the messages may be communicated to at least one remote endpoint via a second of the established plurality of TCP communication channels.

Each of the plurality of different network interfaces may utilize a different network address. The processor 643 may enable placing the first of the plurality of different network interfaces in an out-of-service state prior to communication of the remaining portion of the plurality of messages. The first of the plurality of different network interfaces and the second of the plurality of different network interfaces may each be in either an active state or a standby state. The processor 643 may enable communicating of a subsequent message, to the remaining portion of the plurality of messages, via said first of the plurality of different network interfaces. The first of the plurality of different network interfaces and the second of said plurality of different network interfaces may be associated with said local RNIC. The first of the plurality of different network interfaces may be associated with a first local RNIC and the second of said plurality of different network interfaces may be associated with a different local RNIC.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for transporting information via a communications system, the method comprising:
establishing a plurality of TCP communication channels between a local RDMA enabled NIC (RNIC) and at least one of a plurality of remote RNICs, wherein each of said plurality of TCP communication channels is communicatively coupled to a plurality of different network interfaces at said local RNIC;
establishing RDMA connections between one of a plurality of local RDMA endpoints and at least one remote RDMA endpoint utilizing said established plurality of TCP communication channels;
communicating a portion of a plurality of messages from said one of said plurality of local RDMA endpoints communicatively coupled to a first of said plurality of different network interfaces at said local RNIC to said at least one remote RDMA endpoint communicatively coupled to one of said plurality of remote RNICs via a first of said established plurality of TCP communication channels; and
communicating a remaining portion of said plurality of messages from said one of said plurality of local RDMA endpoints communicatively coupled to a second of said plurality of different network interfaces at said local RNIC to said at least one remote RDMA endpoint via a second of said established plurality of TCP communication channels.

2. The method according to claim 1, wherein each of said plurality of said different network interfaces utilizes a different network address.

3. The method according to claim 1, further comprising placing said first of said plurality of different network interfaces in an out-of-service state prior to communication of said remaining portion of said plurality of messages.

4. The method according to claim 1, wherein at least one of the following: said first of said plurality of different network interfaces and said second of said plurality of different network interfaces, are in one of the following: an active state and a standby state.

5. The method according to claim 4, further comprising communicating a subsequent to said remaining portion of said plurality of messages via said first of said plurality of different network interfaces.

6. The method according to claim 1, wherein said first of said plurality of different network interfaces and said second of said plurality of different network interfaces are associated with said local RNIC.

7. The method according to claim 1, wherein said first of said plurality of different network interfaces is associated with said local RNIC and said second of said plurality of different network interfaces is associated with a subsequent local RNIC.

8. A machine-readable storage having stored thereon, a computer program having at least one code section for transporting information via a communications system, the at least one code section being executable by a machine for causing the machine to perform steps comprising:
establishing a plurality of TCP communication channels between a local RDMA enabled NIC (RNIC) and at least one of a plurality of remote RNICs, wherein each of said plurality of TCP communication channels is communicatively coupled to a plurality of different network interfaces at said local RNIC;
establishing RDMA connections between one of a plurality of local RDMA endpoints and at least one remote RDMA endpoint utilizing said established plurality of TCP communication channels;
communicating a portion of a plurality of messages from said one of said plurality of local RDMA endpoints communicatively coupled to a first of said plurality of different network interfaces at said local RNIC to said at least one remote RDMA endpoint communicatively coupled to one of said plurality of remote RNICs via a first of said established plurality of TCP communication channels; and
communicating a remaining portion of said plurality of messages from said one of said plurality of local RDMA endpoints communicatively coupled to a second of said plurality of different network interfaces at said local RNIC to said at least one remote RDMA endpoint via a second of said established plurality of TCP communication channels.

9. The machine-readable storage according to claim 8, wherein each of said plurality of said different network interfaces utilizes a different network address.

10. The machine-readable storage according to claim 8, further comprising code for placing said first of said plurality of different network interfaces in an out-of-service state prior to communication of said remaining portion of said plurality of messages.

11. The machine-readable storage according to claim 8, wherein one of the following: said first of said plurality of different network interfaces and said second of said plurality of different network interfaces, are in one of the following: an active state and a standby state.

12. The machine-readable storage according to claim 11, further comprising code for communicating a subsequent to said remaining portion of said plurality of messages via said first of said plurality of different network interfaces.

13. The machine-readable storage according to claim 8, wherein said first of said plurality of different network interfaces and said second of said plurality of different network interfaces are associated with said local RNIC.

14. The machine-readable storage according to claim 8, wherein said first of said plurality of different network interfaces is associated with said local RNIC and said second of said plurality of different network interfaces is associated with a subsequent local RNIC.

15. A system for transporting information via a communications system, the system comprising:
a processor that enables establishing a plurality of TCP communication channels between a local RDMA enabled NIC (RNIC) and at least one of a plurality of remote RNICs, wherein each of said plurality of TCP communication channels is communicatively coupled to a plurality of different network interfaces at said local RNIC;
said processor enables establishing RDMA connections between one of a plurality of local RDMA endpoints and at least one remote RDMA endpoint utilizing said established plurality of TCP communication channels;
said processor enables communicating a portion of a plurality of messages from said one of said plurality of local RDMA endpoints communicatively coupled to a first of said plurality of different network interfaces at said local RNIC to said at least one remote RDMA endpoint communicatively coupled to one of said plurality of remote RNICs via a first of said established plurality of TCP communication channels; and
said processor enables communicating a remaining portion of said plurality of messages from said one of said plurality of local RDMA endpoints communicatively coupled to a second of said plurality of different network interfaces at said local RNIC to said at least one remote RDMA endpoint via a second of said established plurality of TCP communication channels.

16. The system according to claim 15, wherein each of said plurality of said different network interfaces utilizes a different network address.

17. The system according to claim 15, wherein said processor enables placing said first of said plurality of different network interfaces in an out-of-service state prior to communication of said remaining portion of said plurality of messages.

18. The system according to claim 15, wherein at least one of the following:
said first of said plurality of different network interfaces and said second of said plurality of different network interfaces, are in one of the following: an active state and a standby state.

19. The system according to claim 18, wherein said processor enables communicating a subsequent to said remaining portion of said plurality of messages via said first of said plurality of different network interfaces.

20. The system according to claim 15, wherein said first of said plurality of different network interfaces and said second of said plurality of different network interfaces are associated with said local RNIC.

21. The system according to claim 15, wherein said first of said plurality of different network interfaces is associated with said local RNIC and said second of said plurality of different network interfaces is associated with a subsequent local RNIC.
